(19) United States
(12) Patent Application Publication
(10) Pub. No.: US 2008/0022588 A1
(43) Pub. Date: Jan. 31, 2008

(54) Tree ring

(76) Inventor: Derek S. Tijerina, Shady Shores, TX (US)

Correspondence Address: LITMAN LAW OFFICES, LTD., P.O. BOX 15035, CRYSTAL CITY STATION, ARLINGTON, VA, 22215, US

(21) Appl. No.: 11/878,643

(22) Filed: Jul. 25, 2007

Related U.S. Application Data
(60) Provisional application No. 60/832,975, filed on Jul. 25, 2006.

(51) Int. Cl. A01G 13/00

(52) U.S. Cl. 47/32

(57) ABSTRACT

The tree ring is a one-piece device formed from a planar member shaped as an annulus that defines a central opening. Disposed along an outer edge of the planar member is a raised wall for retaining mulch, soil nutrients, and the like in the immediate region surrounding a tree. The raised wall extends to an upper portion to form an arcuate, inverted U-shaped lip directed away from the central opening. When the tree is disposed through the central opening, the wall and planar member cooperate to retain mulch material about the base of a tree. The upper portion lip limits encroachment of grass and weeds upon the tree while providing an esthetically pleasing appearance. The lip is designed to provide sufficient clearance so that a lawn mower, string trimmer, and the like, may be run proximate to the device without disturbing the tree or surrounding mulch.

### CROSS-REFERENCE TO RELATED APPLICATION

This application claims the benefit of U.S. Provisional Patent Application Ser. No. 60/832,975, filed Jul. 25, 2006.

### BACKGROUND OF THE INVENTION

1. Field of the Invention

The present invention relates to landscaping devices for preventing the growth of weeds and aiding in mulching plantings, and particularly to a tree ring that can be placed around a tree during planting to retard the growth of weeds and retain moisture around the base of the tree.

2. Description of the Related Art

Newly planted trees require time to take root. During that time the trees roots are in competition with weeds for moisture and food. While feeding the newly planted tree can be done by including appropriate nutrients in the hole dug for the root ball, the competition for moisture is never ending. Most newly planted trees are surrounded by mulch, both to retain moisture and to prevent weed growth, and may also be surrounded by a skirt of fabric or plastic material surrounding the trunk of the tree for the same purpose. Nevertheless, weeds from the surrounding grassy areas have a tendency to creep up towards the base of the tree.

Various plant borders and rings for placement around the base of trees have been proposed. However, all of the tree rings on the market are designed to be placed around the tree after it is planted. This requires them to be a minimum of two pieces with vertical joints where the pieces come together. The problem is that these joints are weak points where weeds and grass can penetrate to gain access to the protected area inside the bounds of the tree ring. Weeds also grow up and over the tree rings as well as under them. Thus, a tree ring solving the aforementioned problems is desired.

### SUMMARY OF THE INVENTION

The tree ring is a one-piece device formed from a planar member shaped as an annulus and defining a central opening therein. Disposed along an outer edge of the planar member is a raised wall that provides a means for retaining mulch, soil nutrients, and the like in the immediate region surrounding a tree. The raised wall extends to an upper portion to form an arcuate, inverted U-shaped lip that is directed away from the central opening. When the tree is disposed through the central opening, the wall and annulus portion cooperate to retain mulch material about the base of a tree. The upper portion lip limits encroachment of grass and weeds upon the tree while providing an esthetically pleasing appearance. The lip is designed to provide sufficient clearance so that a lawn mower, string trimmer, clipper, or similar landscape maintenance device may be run proximate to the device without disturbing the tree or surrounding mulch.

These and other features of the present invention will become readily apparent upon further review of the following specification and drawings.

### BRIEF DESCRIPTION OF THE DRAWINGS

FIG. 1 is a perspective view of a tree ring according to the present invention.

FIG. 2 is a perspective view of the tree ring according to the present invention, broken away and partially in section to show details of the invention.

Similar reference characters denote corresponding features consistently throughout the attached drawings.

### DETAILED DESCRIPTION OF THE PREFERRED EMBODIMENT

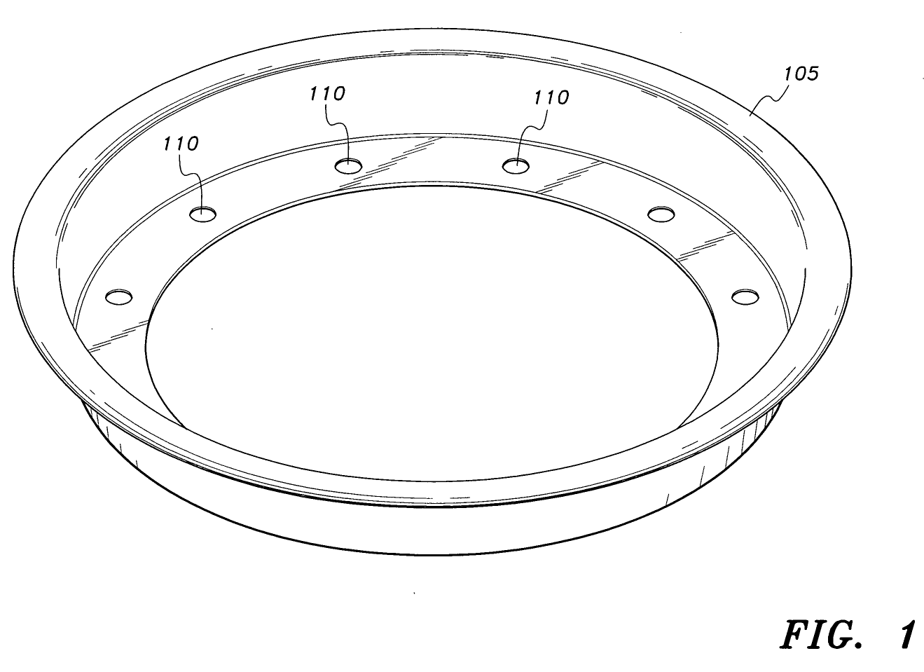

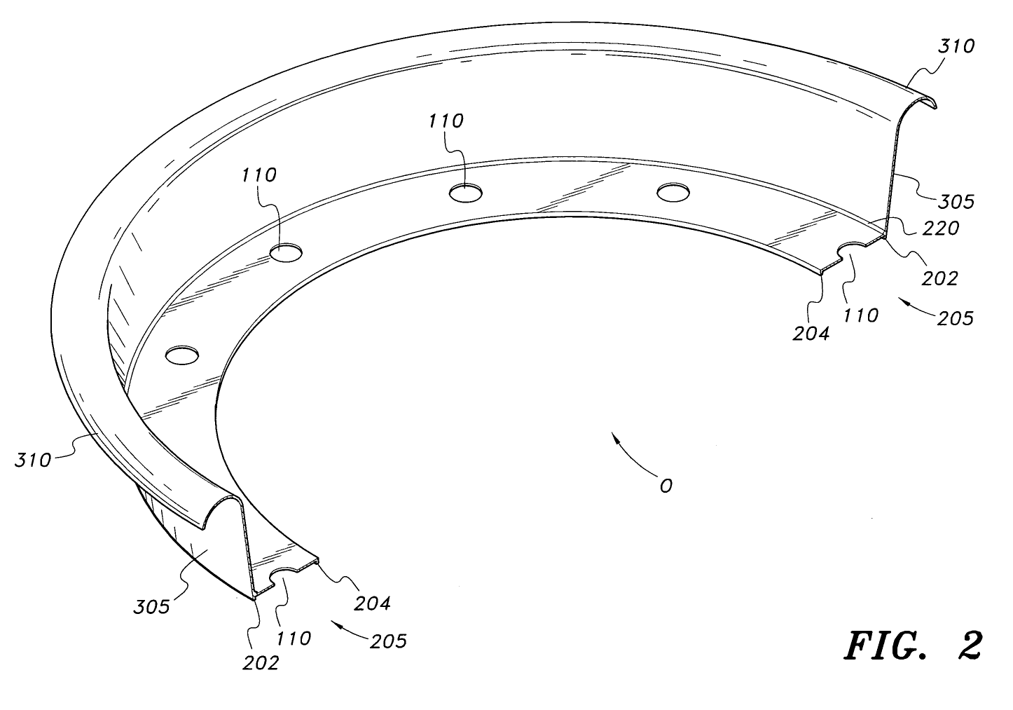

As shown in FIG. 1, the present invention relates to a tree ring that is placed around the base of a tree during planting as a mulch retainer and weed barrier. As shown in FIGS. 1 and 2, the tree ring 105 is a one-piece device formed out of a generally planar member 205 shaped as an annulus and defining a central opening O therein. Disposed along an outer edge of the planar member 205 is a raised wall 305 that provides a means for retaining mulch, soil nutrients, and the like in the immediate region surrounding the tree. A bonding seam 220 may be formed where the raised wall 305 joins the planar member 205, or the tree ring 105 may be formed as a single piece in a suitable mold without such a bonding seam 220. There may also be a factory-installed vertical bonding seam at 305. The raised wall 305 may be canted or slightly angled outward relative to vertical in order to provide easy stacking of a plurality of tree rings 105 for storage, shipping, display, and the like. In addition, the outward slope of wall 305 helps to prevent weeds growing outside the ring 105 from climbing over the wall 305 and taking root inside the ring 105.

The raised wall 305 extends to an upper portion that forms an arcuate, inverted U-shaped lip 310. Preferably, the lip 310 is disposed radially away from the central opening O. When a tree is disposed through the central opening O, the wall 305 and planar member 205 cooperate to retain mulch material about the base of the tree.

Moreover, the lip 310 being disposed radially away from the central opening O functions to turn grass and weeds away and prevent their encroachment upon the tree while providing an esthetically pleasing appearance. Lip 310 also functions to stiffen wall 305 and help it hold its shape. Additionally, the lip 310 retraces only a predetermined portion of the extent of raised wall 305 so as to provide sufficient clearance for lawn mower, string trimmer, clipper, or similar landscape maintenance device operations proximate to the device 105. Planar member 205 provides a flat surface that can be overlapped with a landscape fabric (e.g., burlap or plastic sheet mulch) to help retain moisture and prevent the growth of weeds.

The tree ring 105 may be fabricated from a variety of materials, including concrete; metal; synthetic polymeric materials, including reinforced polymeric materials; rubber, and the like. In order to secure positioning of the tree ring 105 around a tree, a plurality of device retaining holes 110 may be provided, through which retaining spikes may be driven into the ground.

Two downward extending flanges or legs 202 and 204 may be provided on the underside of the tree ring 105 so that a channel is created underneath planar member 205. Upon placement of the device 105 on soil, the legs 202 and 204 cooperate with the underside of planar member 205 to firmly seat the device 105 on top of the soil, while providing an additional benefit of sealing out weeds under planar member 205. As mentioned above, landscape fabric can be overlaid on top of the planar member 205 for additional weed control.

Unlike previous tree rings, the tree ring 105 is designed to be installed during planting prior to placing the tree in the hole. A hole is dug for the root ball, and the tree ring is placed around the hole. A few landscaping spikes may be driven through holes 110 to secure the ring 105 to the soil. The root ball is then inserted into the hole and covered with soil. Loose mulch may be placed around the trunk of the tree, or a landscaping fabric may be placed around the tree and the remaining landscaping spikes may be driven through both the fabric and holes 110 to secure both the fabric and the ring to the ground.

Since the ring 105 has no joints splitting the rings 105, no weeds can grow through the joints. The outward slope of wall 305 and the downward turn of lip 310 prevent weeds from spreading from outside the ring 105 to the interior. Moreover, the circular shape of the tree ring 105 permits multiple tree rings 105 of different diameters to be concentrically disposed about the trunk of the same tree in order to provide progressively more distant radial weed barriers about the tree trunk, as well as an aesthetically pleasing appearance.

It is to be understood that the present invention is not limited to the embodiment described above, but encompasses any and all embodiments within the scope of the following claims.

I claim:

1. A tree ring, comprising:
an annular planar member defining a central opening, the planar member defining a peripheral outer edge;
an upright wall extending from the outer edge around the periphery of the planar member, the upright wall having an upper end; and
a lip formed at the upper end of the upright wall and extending around the periphery thereof, the lip having an arcuate, inverted U-shape extending outside the upright wall;
wherein the tree ring is adapted for placement on the ground around a tree trunk in order to retain mulch and to prevent the growth of weeds inside the ring.

2. The tree ring according to claim 1, further comprising: a bonding seam formed where the upright wall joins the planar member.

3. The tree ring according to claim 1, further comprising: a vertical bonding seam along the upright wall for closure of the upright wall.

4. The tree ring according to claim 1, wherein the upright wall is slightly angled outward relative to vertical orientation to facilitate stacking, storage, and use of the tree ring.

5. The tree ring according to claim 1, wherein the extension of the lip outside the upright wall retraces only a predetermined portion of the extent of the upright wall in order to provide sufficient clearance for lawn care equipment operating near the tree ring.

6. The tree ring according to claim 1, wherein the tree ring is fabricated from polymeric materials.

7. The tree ring according to claim 1, further comprising: a plurality of tree ring retaining holes defined in the annular planar member.

8. The tree ring according to claim 1, further comprising a pair of downward extending flanges defining a channel underneath the planar member, the channel cooperating with the underside of the planar member so that the tree ring can be firmly seated on top of the soil, sealing out weeds under the planar member.
